(19) United States
(12) Patent Application Publication
(10) Pub. No.: US 2011/0202232 A1
(43) Pub. Date: Aug. 18, 2011

(54) Hydraulic Lift System And Control Method

(76) Inventors: Jochen Busch, Dimbach (DE); Markus Schober, Kashofen (DE)

(21) Appl. No.: 12/680,782

(22) PCT Filed: Sep. 3, 2008
(86) PCT No.: PCT/EP08/61637

§ 371 Date: Jul. 22, 2010

(30) Foreign Application Priority Data
Oct. 11, 2007 (DE) 10 2007 048 697.0

(51) Int. Cl. E02F 9/20; A01B 59/043; G06F 19/00; E02F 3/36; A01B 63/10

(52) U.S. Cl. 701/36; 172/439; 414/686; 60/459

(57) ABSTRACT

A hydraulic hitch system for a vehicle includes a hydraulic source, a hydraulic reservoir, a hydraulic cylinder, an operator-controlled actuating means for generating a command signal, a hydraulic control valve for controlling the hydraulic cylinder, and an electronic control unit for controlling the control valve. To make it easier for the operator to set the hydraulic functions when working with different attachments, a pressure sensor generates a pressure signal and is connected to the hydraulic cylinder, and a control device is used to select a pressure control program for the hydraulic cylinder. The control valve is activated by a control signal which is generated by the control unit as a function of the selected pressure control program, the pressure signal and a command signal generated by the control device.

The invention concerns a hydraulic lifting arrangement for an industrial utility vehicle, particularly a construction machine or an agricultural vehicle, with a source of hydraulic fluid, a hydraulic reservoir, at least one hydraulic cylinder, an actuating device for the input of an adjusting signal by an operator, an electronic control unit, and a hydraulic control valve for the control of the hydraulic cylinder, where the control valve can be controlled by the electronic control unit. Moreover, the invention concerns a process for a hydraulic lifting arrangement.

Hydraulic lifting arrangements with double acting hydraulic cylinders are today components of the standard configuration of an agricultural machine, such as, for example, a tractor, where various operating applications apply various demands to the lifting device. So that, for example, during front loader operations, in which the front loader includes such a lifting device, a double acting hydraulic cylinder is usually applied for the lifting and lowering of the front loader, where both chambers of the hydraulic cylinder can be supplied with pressure according to the positioning signals from the operator. In operations with a lifting device arranged for a front attachment arrangement or attachment linkage for an operating implement, a double acting hydraulic cylinder frequently has disadvantages, since several operating implements or attachment implements, for example, mowing implements, are not designed for double acting hydraulic cylinders or for a pressure load. In these cases, an operator must readjust the control valve for the hydraulic cylinder in a timely manner upon the lowering of the lifting arrangement from a pressure applying control position to a pressure-free control position or a floating position, in order to avoid any damage to the operating implement or the attached implement. This requires increased care and attention by the operator. Moreover, during operation with an attachment implement, for example, a front coupled implement, it is usual practice in which a double acting hydraulic cylinder is used, for example during operation with a front packer.¹ In order to provide an ideal effect, a front packer must be forced against the ground with a certain pressure. Usually an operator uses a pressure gage, according to which the operator is guided during the lowering of the front attached implement, until the desired pressure (contact pressure) is reached. Subsequently the hydraulic cylinder is blocked hydraulically or stopped. In the case of uneven ground the contact pressure of the operating implement varies, so that a constant result of the operation is not guaranteed.

The problem underlying the invention is seen in the need to create a hydraulic lifting arrangement of the type cited initially by means of which the aforementioned problems are overcome.

The problem is solved according to the intention by the teaching of patent claims 1 and 14. Further advantageous embodiments and further developments of the invention follow from the subordinate claims.

According to the invention the hydraulic lifting arrangement of the type cited initially is configured in such a way that a pressure sensor connected to the hydraulic cylinder and a selection instrument is provided with at least one pressure control program for the hydraulic cylinder, where the control valve can be controlled by a signal generated by the control unit as a function of the selection of the pressure control program, and/or a pressure signal delivered by the pressure sensor and/or can be generated by the adjusting signal from the operator. The operator can provide as input upon initial operation of the lifting device by means of a selection device, for example, a digital selection and indication module, which pressure control program, is to be activated. Several pressure control programs may be stored in memory or implemented in the electronic control unit, that provide various inputs for the generation of control signals provided by the electronic control unit for the hydraulic control valve. In that way for example, control algorithms can be brought into action, as a function of the selection of the pressure control program that generates various pressure signals for the hydraulic control valve as a function of a pressure value generated by the pressure sensor. Moreover, control signals may be considered that were provided as input by the operator by means of a control lever (joystick). Moreover, in addition, the pressure control program can also provide for a combination of the control signals provided as input by the operator and the pressure values delivered by the pressure sensor be utilized for the generation of control signals for the hydraulic control valve. A closed control circuit can be created as a function of the pressure value delivered by the pressure sensor and may for example be provided by the pressure target value or the pressure control value stored in memory in the electronic control unit, so that, for example, a pressure existing in the hydraulic cylinder is adjusted by corresponding control of the hydraulic control valve or by the generation of a corresponding control signal for the hydraulic control valve, is adjusted as a function of the pressure target value or the pressure control value. A lifting arrangement, according to the invention, can obviously be operated with two or more hydraulic cylinders that preferably are arranged in a parallel circuit.

Preferably the hydraulic cylinder is connected to a lifting linkage provided for the lifting and lowering of an operating implement and a chamber that can be supplied in each case with pressure for the retraction and extension of the hydraulic cylinder, where the retraction and extension of the hydraulic cylinder is associated with the raising and lowering of the lifting linkage. Hence provision can be made for the hydraulic cylinder to be connected with a lifting linkage configured as a loading arm or an oscillating crank that carries an operating implement configured as a shovel or loading fork, etc. . . . Other configurations of the lifting linkage, for example, a front loader, a coupling arrangement (for example, a front or rear coupling arrangement) or an attaching linkage for a coupled implement or an attached implement are also possibilities. By the same token, other configurations of an operating implement are also conceivable and should be included here, for example any sort of front harvesting attachments, front mowing attachments, ground breaking tools, front loader tools, construction machine tools, etc. The lifting linkage is coupled to the hydraulic cylinder in such a way that by actuating, that is by applying hydraulic pressure to the hydraulic cylinder, a lifting or lowering of the lifting linkage and with it the operating implement is performed. Here it is a function of the mechanical arrangement which of the two chambers of the hydraulic cylinder is to be supplied with pressure for the raising or lowering of the lifting linkage.

The pressure sensor is preferably connected hydraulically to the chamber that can be supplied with hydraulic pressure for the lowering of the lifting linkage. Thereby the pressure sensor delivers pressure values that develop in the chamber that is to be supplied with pressure for the lowering of the lifting linkage. Thereby a pressure target value can be adjusted or controlled or maintained at a constant level by the electronic control unit or provided as input in the chamber by means of the aforementioned closed control circuit, so that a lifting linkage or an operating implement can be forced against the ground by means of this constant pressure or lowered. Thereby the operation can also be performed without pressure, in that the pre-adjusted pressure target value is set to 0 and is provided as input or adjusted initially. This would then equal the operation of a hydraulic cylinder loaded on one side only, since the chamber that can be supplied with pressure for the lowering is held with 0 pressures. Obviously an analogous procedure is also possible for the pressurized chamber (pressure target value≧0 bar) as well as the 0 pressure chamber (pressure target value=0 bar) also for the chamber that is to be pressurized for lifting.

Preferably the control valve is configured as a proportional valve, a 4/4 way valve. Other valves or other valve combinations are also possible, for example, 2/2 way valves switched synchronously, or other combinations that permit comparable control of the hydraulic flow. Here it is also conceivable to apply a 4/3 way valve, where, for example, a first switch position of the control valve connects one chamber of the hydraulic cylinder with the hydraulic pump, a second switch position connects the other chamber of the hydraulic cylinder with the hydraulic pump, while a third switch position separates both chambers from the hydraulic pump. A fourth switch position that may for example be a floating position, in which both chambers are connected with each other, is omitted when using a 4/3 way valve. Such a floating position can be attained electronically with a corresponding electronic control as described in the following.

The electronic control unit is configured in such a way that a first pressure control program is implemented in it or that a first control algorithm foresees, that a control signal is generated in which the chamber that can be supplied with hydraulic pressure for the lowering of the lifting linkage is held to zero pressure. Hence the pressure in this chamber is controlled to zero bar, in that the pressure readings delivered by the pressure sensor induce the electronic control unit to generate an electronic control signal or a pressure correction signal in case the pressure in the chamber that can be supplied with pressure to lower the lifting linkage differs from zero. Such a control is equal to a so-called “floating position”, since the operating implement or the lifting linkage can move upward without interference and hence can follow any possible unevenness in the ground to be operated upon or the subsoil almost without any hindrance, where only the weight of the lifting linkage and the operating implement operate upon the ground or subsoil.

Moreover, the electronic control unit may be configured in such a way that a second pressure control program implemented in it or a second control algorithm provides for the generation of a control signal, with which the chamber that can be supplied with hydraulic pressure for the lowering of the lifting linkage can be held to a pre-determined pressure (pressure target value). A corresponding pressure value or pressure target value or pressure control value can preferably be provided as input by the operator by means of the selection instrument, in that the operator provides the pressure target value as input. The input is performed, for example, by means of an input module provided in the selection instrument. The pressure target value however can previously have been stored in memory or implemented in the control unit and provided as input for example, by means of a control program (control algorithms). Thereby the pressure in this chamber is controlled to the predetermined pressure target value or the pressure target value provided as input, in that the pressures delivered by the pressure sensor induces the control unit to generate a corresponding control signal or a pressure correction signal, in case the pressure, in the chamber that can be supplied with pressure for the lowering of the lifting linkage differs from the pressure target value. Such a control arrangement is practically equal to a “floating position with contact pressure”, since the operating implement or the lifting linkage can move upward only against the pressure existing in the chamber. In that way the operating implement or the lifting linkage can follow any possible uneven areas on the ground to be operated upon or the subsoil only under the effect of the pressure input value or the pressure target value provided that generates a certain contact pressure and the force opposing the force of gravity, where at a level subsoil a consistent contact pressure is applied, and the pressure in the chamber remains constant according to the pressure target value, in case of a wave in the ground directed upward the pressure in the chamber and hence the contact pressure applied is increased and the electronic control unit is controlled downward according to the pressure target value and in the case of a downward wave in the ground the pressure in the chamber and with it the contact pressure is lowered and controlled upward automatically by the electronic control unit according to the pressure target value.

Moreover, preferably the electronic control unit is configured in such a way that a third pressure control program or a third algorithm is implemented in it which provides that a control signal can be generated, that foresees that the pressure in the chamber that can be supplied with pressure to lower the lifting linkage and the chamber that can be supplied with pressure to raise the lifting linkage can be varied. This pressure control program accordingly foresees no limit or control of the pressure in the chamber that can be supplied with pressure for the lowering of the lifting linkage, but instead permits automatic control of the hydraulic cylinder corresponding to the positioning signal provided as input by the operator by means of the actuating device. This third pressure control program corresponds to a pressure control program usually installed, in which the lifting linkage or the lifting arrangement is operated or controlled solely according to control commands provided as input by the operator, in which therefore automatically a translation of the control signal provided as input by the operator is performed by an actuating device (Joystick) translated to actuation of the hydraulic cylinder for the raising or lowering of the lifting linkage. Preferably provision can be made, moreover, for the third pressure control program to be prioritized in such a way that the electronic control unit is operated according to one of the other selected pressure control programs or generates its control signals, then an automatic switching into the third pressure control program is performed as soon as the actuating device is activated by the operator, that is as soon as a positioning signal is provided as input and desired by the operator. This has the advantage that the operator does not need to start the automatic third pressure control program by means of the selection instrument.

Preferably the control valve can be actuated electromagnetically by means of electromagnetic coils, where in another configuration an actuation by means of electromechanical devices, for example, by means of an electric motor is also possible. In both cases corresponding control signals are generated by the electronic control unit that controls either the electromagnetic coils or the electric motor. The electric motors applied here may be stepper motors or spindle motors that are coupled to the control valve, if necessary by means of a transmission gearbox connected to the control valve. Moreover the control or the actuation of the proportional control valve can be performed directly or over a pilot step.

The configuration of the lifting linkage and the operating implements can be conceived in multiple ways, of which a few are cited below, where all variations cited fall under the lifting arrangement according to the invention. For example, the lifting linkage is configured as a coupling arrangement for a front or rear operating implement for an agricultural vehicle, particularly as a three point implement hitch, where such a three point implement hitch can be provided at the front of the vehicle as well as at the rear of the vehicle. These operating implements may include all agricultural coupled implements, such as, for example, ground breaking implements or mowing implements or the like. In that way, for example, cultivator operations or plowing operations can be performed with the application of the first or the second pressure control program so that a floating position is achieved for the operating implement or a certain contact pressure is applied to the ground to be processed. Moreover, the lifting linkage can also be configured as a front loader for an agricultural vehicle, particularly for a tractor, where the front loader is equipped for example, with an operating implement in the form of a shovel. In that way, for example, leveling operations can be performed with the shovel in the floating position or with the use of contact pressure upon the ground. Moreover the lifting linkage may be configured as an attachment linkage of the front attachment for an agricultural vehicle, particularly for a harvesting machine, where the attachment linkage is equipped, for example, with a harvest retainer or a front mowing attachment as a front harvesting attachment or operating implement. Here, for example, the first pressure control can be applied, so that the front harvesting attachment can follow the contour of the ground in its “floating position” and for example, is not damaged by a sudden wave in the ground. By the same token it is conceivable to apply the lifting arrangement to a construction machine, where the lifting linkage is configured as a loader link, for example, for a wheel loader or a leveling crawler. Here too, all three of the pressure control programs are appropriate, that can be provided as basis of the operating application for the control of the control valve. But the application to other industrial utility vehicles is also conceivable which are not cited here in this connection.

A process aimed at the hydraulic lifting arrangement, according to the invention, for an industrial utility vehicle, particularly a construction machine or an agricultural vehicle, such as a wheel loader or a tractor, provides that with a source of hydraulic power, a hydraulic reservoir, a double acting hydraulic cylinder, an actuating device for the input of a positioning signal by an operator, an electronic control unit, and a hydraulic control valve for the control of the hydraulic cylinder, where the control valve can be controlled by the electronic control unit, to attain an electro-hydraulic control, in which a pressure sensor and a selection device for the selection of at least one pressure control program for the hydraulic cylinder is provided and the control valve is controlled by a control signal generated by the control unit, that is generated as a function of the selection of the pressure control program and/or a pressure signal delivered by the pressure sensor and/or is generated by the adjusting signal from the operator.

Moreover, the process provides that the hydraulic cylinder be connected with a lifting linkage provided for the raising and lowering of the operating implement and be provided with a chamber that can be supplied with pressure, in each case for the retraction and extension of the hydraulic cylinder, where a retraction and extension of the hydraulic cylinder is associated with the raising and lowering of the lifting linkage.

Moreover, the process provides that a control signal be generated by the control unit with a first pressure control program with which the pressure in the chamber is supplied with hydraulic fluid for the lowering of the lifting linkage is held to zero bar.

In a second pressure control program a control signal is generated, in which the pressure in the chamber that can be supplied with pressure for the lowering of the lifting linkage is maintained at a constant value that is provided as input by the selection instrument.

Moreover, in a third pressure control program a control signal is generated, with which the pressure in the chamber that can be supplied with pressure for the lowering of the lifting linkage and the pressure in the chamber that can be supplied with pressure for the raising of the lifting linkage can be varied.

As noted previously, the hydraulic lifting arrangement, according to the invention, is appropriate for many types of industrial utility vehicles, such as, for example, tractors, harvesting machines, forestry machines or construction machines or applicable to the application to such industrial utility vehicles.

The drawing shows an embodiment of the invention, as well as further advantages and advantageous further developments and embodiments of the invention that shall be described in greater detail in the following.

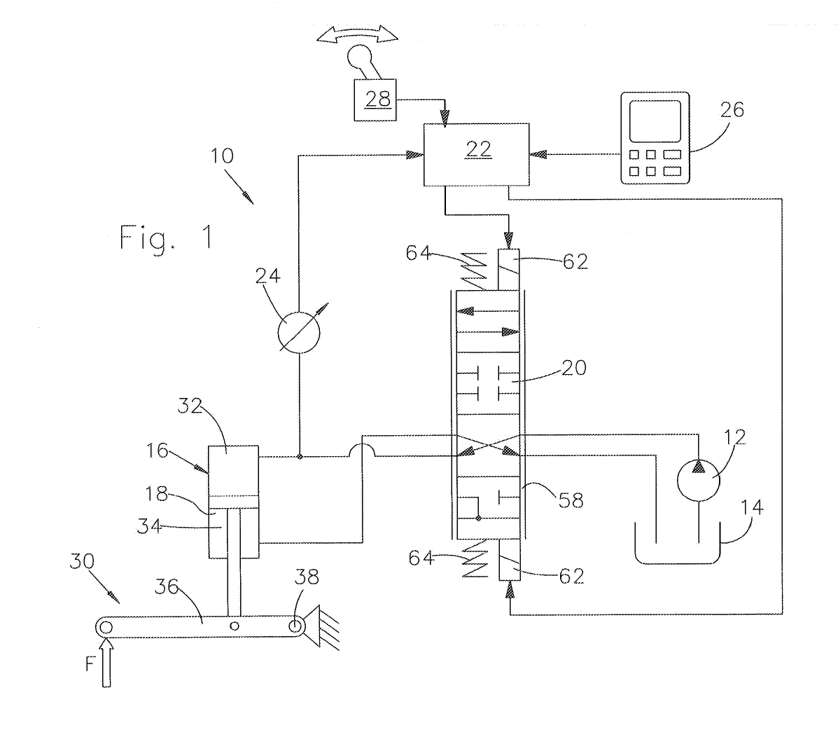

FIG. 1 shows a schematic circuit diagram of a hydraulic lifting arrangement according to the invention with an electromagnetically operated control valve,

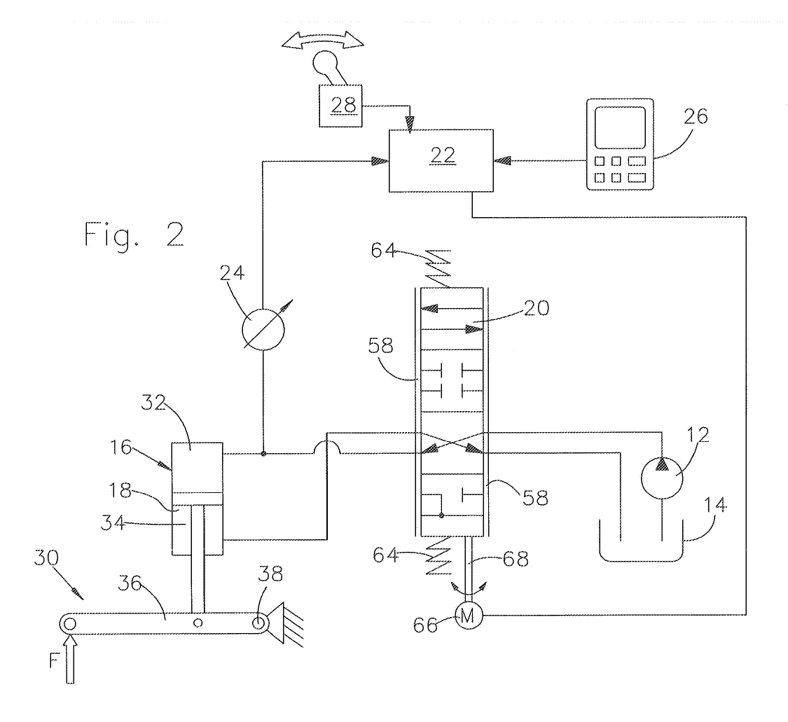

FIG. 2 shows a schematic circuit diagram of a hydraulic lifting arrangement according to the invention, with an electro-mechanically actuated control valve,

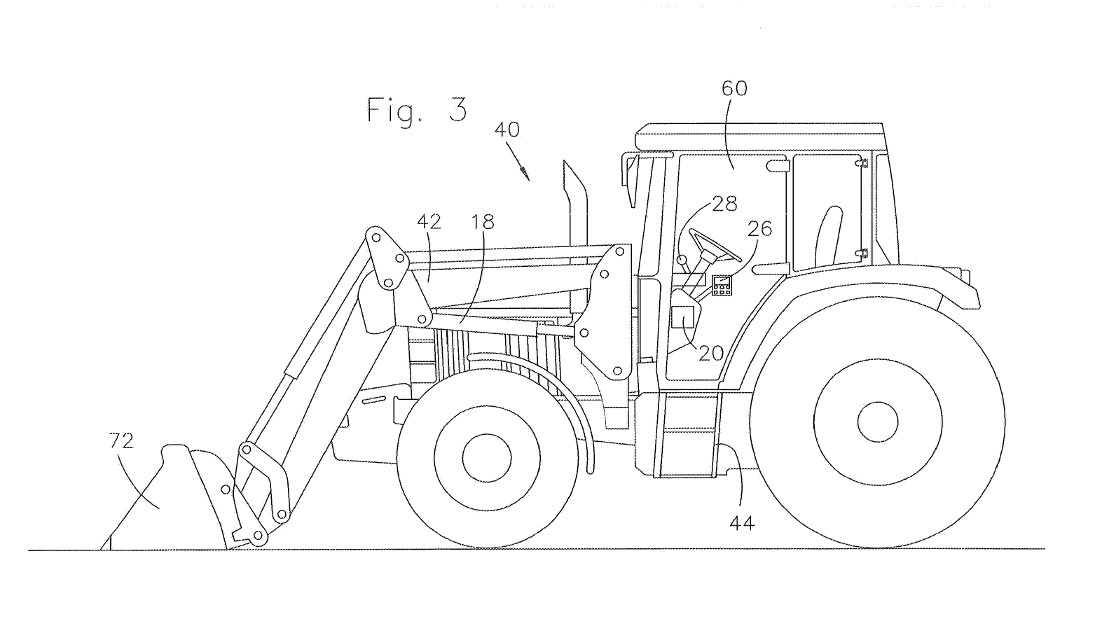

FIG. 3 shows a side view of tractor with a hydraulic lifting arrangement, according to the invention, in the form of a front loader,

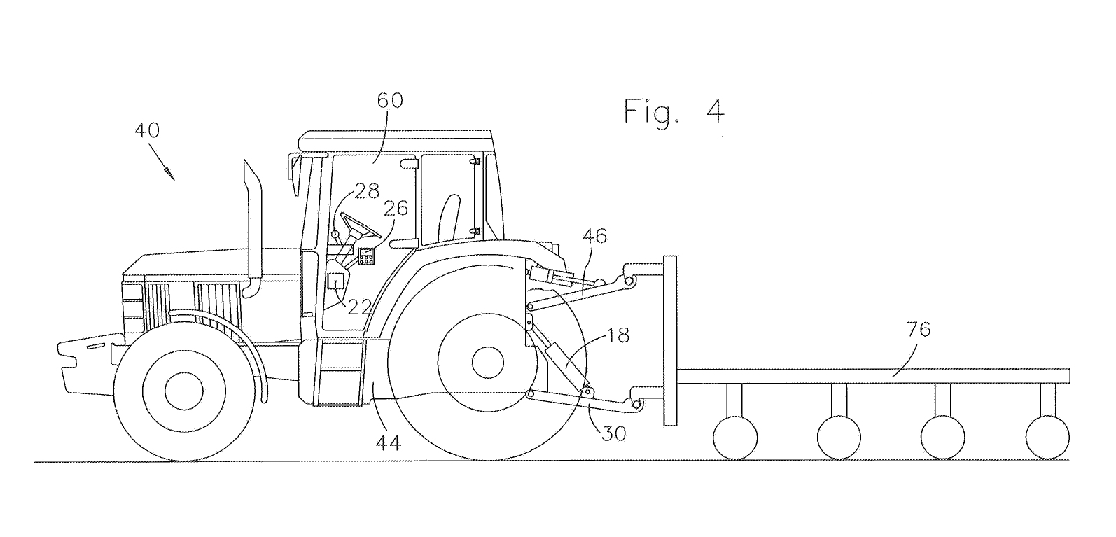

FIG. 4 shows a side view of a tractor with a hydraulic lifting arrangement, according to the invention, in the form of a coupling arrangement for a coupled implement,

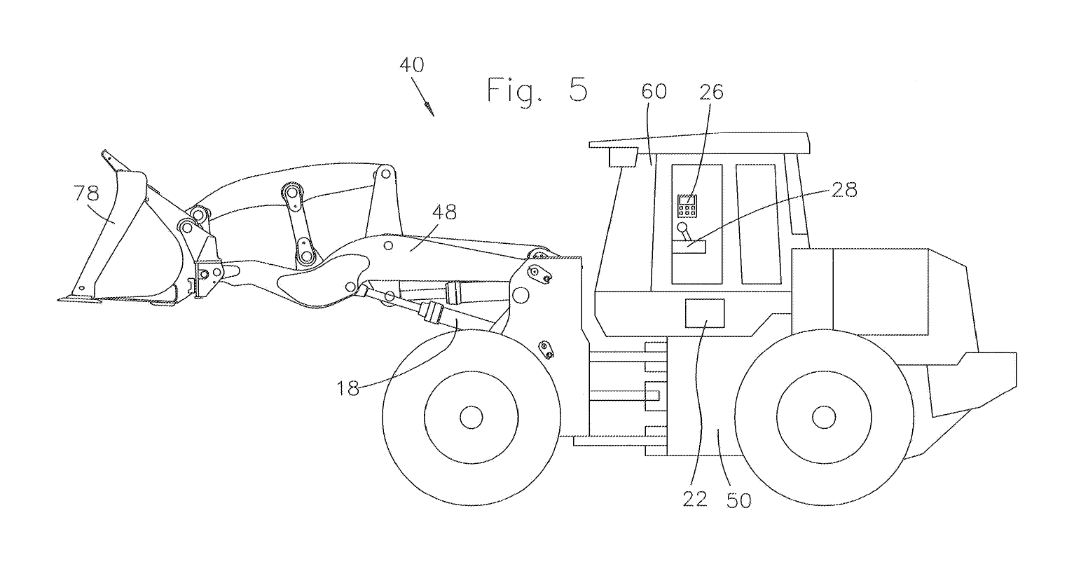

FIG. 5 shows a side view of a wheel loader with a hydraulic lifting arrangement, according to the invention, in the form of an oscillating loader,

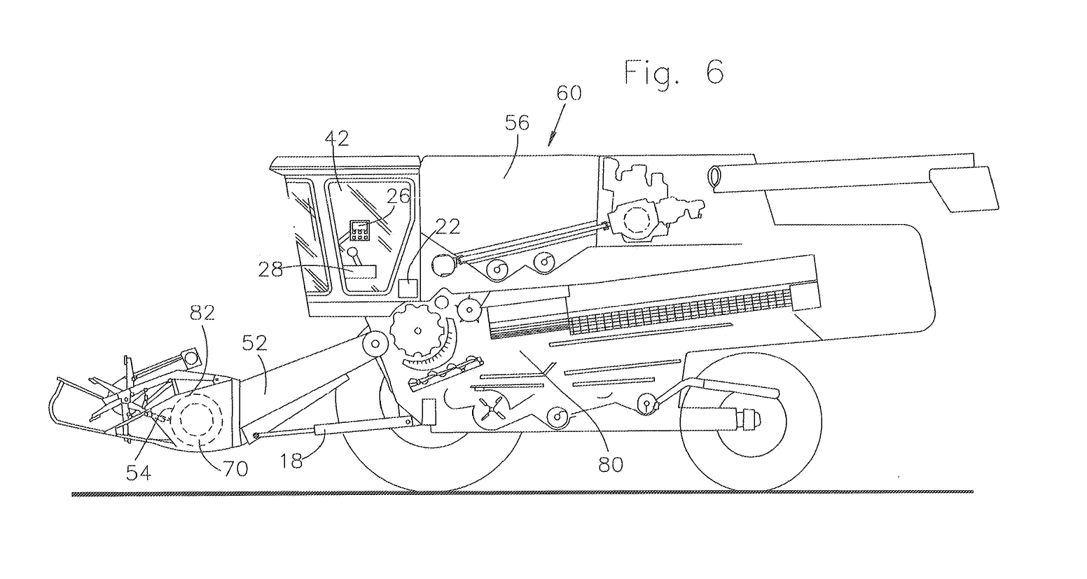

FIG. 6 shows a side view of a wheel loader with a hydraulic lifting arrangement, according to the invention, in the form of an attaching linkage for a front harvesting attachment and

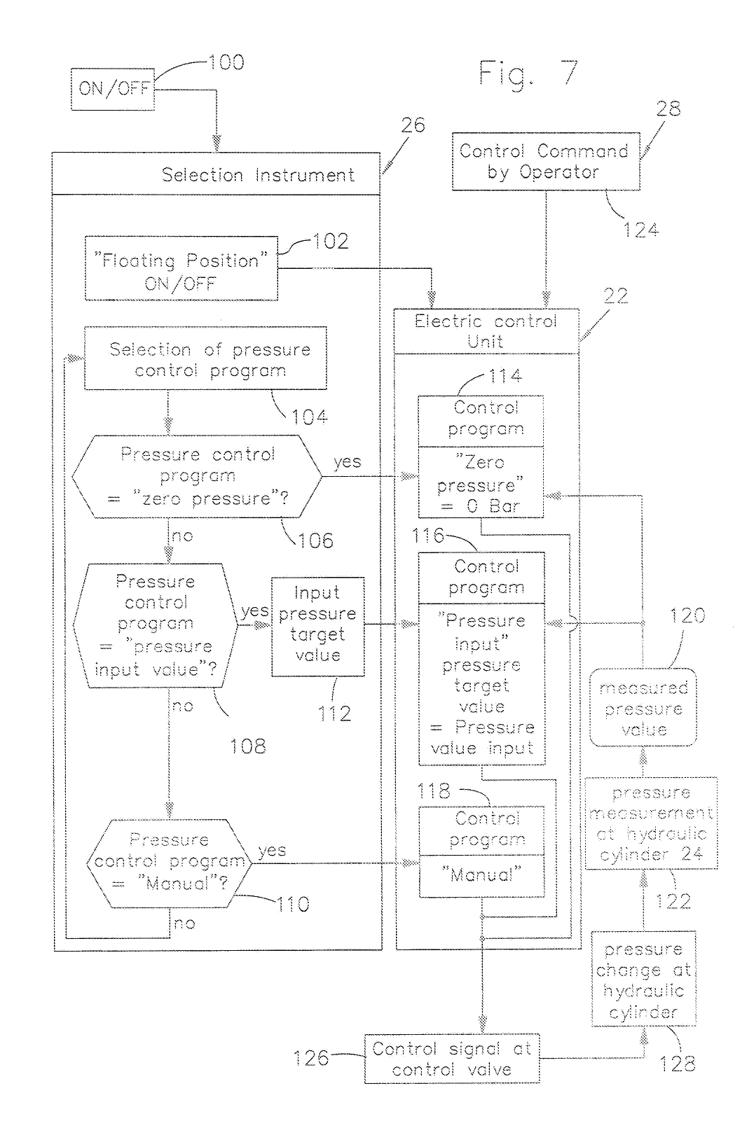

FIG. 7 a process scheme for a lifting arrangement, according to the invention, in the form of a block diagram (flow chart).

FIGS. 1 and 2 schematically show a hydraulic lifting arrangement 10 according to the invention. The hydraulic lifting arrangement 10 includes a source 12 of hydraulic fluid in the form of a hydraulic pump, a hydraulic reservoir 14 configured as a hydraulic tank, a hydraulic actuator 16 in the form of a double acting hydraulic cylinder 18 with a piston 19, an electronically controllable control valve 20, an electronic control unit², a pressure sensor 24, a selection instrument 26 and an actuating device 28 in the form of an adjusting lever or a joystick. Moreover, the lifting arrangement 10 includes a lifting linkage 30.

The hydraulic pump 12 supplies the hydraulic lifting arrangement with hydraulic fluid that is conveyed from the hydraulic reservoir 14.

The hydraulic cylinder 18 is configured as a double-acting hydraulic cylinder, that is, it includes two chambers 32, 34 that can be supplied with pressure, where one chamber 32 is configured as a piston chamber and the other chamber 34 is configured as a rod chamber. The lifting linkage 30 includes a steering arm 36 that is fastened to an appropriate attaching point on the vehicle 40 by means of a pivot bearing 38 (see FIGS. 3 through 6). The steering arm 36 is shown here as an example as a simple pivoted steering arm, that is connected to the rod side of the hydraulic cylinder 18. The lifting linkage 30 can represent many forms of steering arms 36 or steering arm arrangements that can be applied to an industrial vehicle or agricultural vehicle or a construction vehicle 40 that is shown as an example in FIGS. 3 through 6. In that way the steering arm 36 can be a component of a front loader 42 on a tractor 44, a coupling arrangement 46 on a tractor 44, an oscillating loader 48 of a wheel loader 50, an attachment arrangement 52 for a front harvesting attachment 54 of a harvesting machine 56 and many more. The steering arm 36 may be connected to the rod side instead of the piston side of the hydraulic cylinder 18.

In the embodiment shown in FIGS. 1 and 2 the steering arm 36 is connected to the hydraulic cylinder 18 on the rod side in such a way that a force F applied from below to the steering arm 36 moves the piston 19 in the direction of the piston side chamber 32 and there generates an increase in the pressure. The other way around, a pressure established in the piston chamber 32 results in a force that forces the steering arm 36 downward and that generates in turn a corresponding contact pressure for the lifting linkage 30 or for an operating implement coupled to the lifting linkage 30.

In order to monitor or control the pressure in the piston side chamber 32 this chamber 32 is connected hydraulically to the pressure sensor 24. The control valve 20 is configured as a proportional valve with four switching positions (4/4way valve), where in the first switch position (uppermost switch position of the control valve 20 of FIG. 1 or 2) the pump 12 is connected to the chamber 34 and the reservoir 14 is connected to the chamber 32, in the second switch position (second highest switch position of the control valve of FIG. 1 or 2) all connections to the chambers 32, 34 are closed, in the third switch position (switch position of the control valve 20 as shown in FIG. 1 or 2) the pump 12 is connected with the chamber 32 and the reservoir 14 is connected to the chamber 34 and in the fourth switch position (lowest switch position of the control valve 20 of FIG. 1 or 2) both chambers 32, 34 are connected with the reservoir 14, where a conventional floating position is switched thereby. The control valve 20 is provided with a proportional slide valve 58, that can be used for a fine adjustment of the individual switch positions, so that a hydraulic supply flow or a hydraulic drain flow into or out of a chamber 32, 34 can be fine tuned correspondingly in the sense of one of the available switch positions.

In order to control the hydraulic control valve 20 it is connected electronically with the electronic control unit 22. Moreover, the electronic control unit 22 is connected electronically with the selection instrument 26, the actuating device 28 and the pressure sensor 24.

In the first switch position hydraulic fluid is conveyed from the pump 12 to the chamber 34. Simultaneously the chamber 32 is connected with the reservoir 14. As a result the lifting linkage 30 is raised. In the second switch position, the chambers 32, 34 are closed, so that a stopping of the lifting linkage 30 is attained. In a third switch position hydraulic fluid is conveyed from the pump 12 to the chamber 32. Simultaneously the chamber 34 is connected with the reservoir 14. The result is a lowering of the lifting linkage 30 or a downward force is applied to it in the direction of the ground. Depending on the position of the proportional slide valve 58 within the switch positions a corresponding strong or weak lifting or lowering force is achieved.

The actuating device 28 is used as an input device for the input of control commands by the operator, who initiates the lifting, lowering or stopping of the lifting linkage 30 by means of the actuating device 28. Moreover, an additional function can be provided in such a way that the operator can also provide as input a floating position (fourth switch position) by means of the actuating device 28. Preferably the actuating device 28 is arranged in the cab 60 of the vehicle 40. The actuating device 28 is preferably configured as a control lever, where an actuation of the control lever results in a corresponding control command being transmitted to the electronic control unit 22, which then generates a corresponding control signal for the control valve 20. The translation of a control command provided as input by the operator is performed by means of control programs implemented or stored in memory in the control unit 22. Depending on the input of the control program electronic control signals or further control magnitudes provided as input by the selection instrument 26 are considered during the generation of the control signals for the control valve 20.

In the embodiment shown in FIG. 1, the hydraulic control valve 20 is configured as an electro-magnetically controlled control valve, where magnet coils 62 are excited by control signals generated by the electronic control unit 22, in order to move the proportional slide valve 58 of the control valve 20 so as to correspond. In order to provide a fail-safe function adjusting springs 64 are provided, that automatically move the control valve 20 into the second (closed) switch position in case of a power failure.

In an alternative configuration, as shown in FIG. 2, the hydraulic control valve 20 is configured as an electro-mechanically controlled control valve 20. For this purpose a stepper motor 66 is provided, that is connected with the proportional slide 58 of the control valve 20 in order to move the proportional slide 58 according to the control signals generated by the electronic control unit 22. The servomotor 66 is connected to the proportional valve 58 by means of a spindle 68 and is configured as a stepper motor. All further components and method of operations of the configuration shown in FIG. 2 are the same as those of FIG. 1.

The hydraulic lifting arrangement shown schematically in FIGS. 1 and 2 can be operated by means of several control programs, where the selection of a control program is performed by the operator by means of the selection instrument 26. As shown in FIG. 7, three control programs are available, that have been labeled, for example, as pressure control programs (Zero pressure), “pressure input”, and “manual”. Depending on the selection of the pressure control program, the signals delivered by the pressure sensor 24 are considered in the electronic control unit 22 in the generation of the control signal for the control valve 20.

In the selection of “Zero pressure” a pressure value of “0 bar” is provided as pressure target value for the electronic control unit 22, for example, automatically, where the electronic control unit 22 controls the control valve 20 in such a way that the pressure in the piston side-chamber 32 is controlled to zero bar. For this purpose the pressure values delivered by the pressure sensor 24 are utilized for the generation of the control signals that represent the pressure in the chamber 32, along with the pressure provided for the pressure target value (0 bar). The control signals that correspond to the difference of the pressure delivered by the pressure sensor 24 in the piston side chamber 32 and the pressure target value that was provided as input are calculated or generated. As a result of this pressure control program the pressure in the piston side chamber 32 is held to 0 bar, so that as seen functionally the double acting hydraulic cylinder 18 can be operated as a single acting hydraulic cylinder 18 or the piston can move freely, at all times, in the direction of piston side chamber 32. Depending on the configuration and arrangement of the lifting linkage 30 and the type of the application, the operation of the hydraulic cylinder 18 can also be operated functionally in the opposite sense, so that the pressure in the rod chamber 34 is controlled.

In the selection “pressure input” the pressure target value is provided as input by the operator, where the input of the pressure target value can also be performed by means of the selection instrument 26. A corresponding control magnitude is provided as input to the electronic control unit 22 by a corresponding input of the pressure target value, where the electronic control unit 22 controls the control valve 20 in such a way that the pressure in the piston side chamber 32 is controlled to a value corresponding to the pressure target value that was provided as input. For this purpose the pressure values delivered by the pressure sensor 24 for the generation of the control signals, that represent the pressure in the chamber 32 and the pressure target value previously provided as input are utilized, with the difference that here the pressure target value differs from 0 bar. The control signals are then calculated or generated corresponding to the difference between the pressures delivered by the pressure sensor 24 of the piston side chamber 32 and the pressure target value provided as input. As a result of the pressure control program the pressure in the piston side chamber 32 is held to the pressure target value provided as input, so that functionally the double acting hydraulic cylinder 18 at all times applies contact pressure to the lifting linkage 30 corresponding to the pressure target value or that an operating implement connected to the lifting linkage 30 is operated at a contact pressure corresponding to the pressure target value. Depending on the configuration and arrangement of the lifting linkage 30 and the type of application the operation of the hydraulic cylinder 18 can functionally also be performed in the opposite direction so that the pressure in the rod side chamber 34 is controlled.

In the selection “manual” of the operation there is no input of the pressure target value. By actuation of the actuating device 28 the operator provides as input to the electronic control unit 22 whether a pressure increase in the piston side chamber 32 (lowering) or a pressure increase in the rod side chamber 34 (raising) is to occur. The control signals are then calculated or generated by the operator as a function of the actuation of the actuating device 28. As a result of this pressure control program the pressure in the piston side chamber 32 or in the rod side chamber 34 is provided as input by the operator or the hydraulic cylinder is controlled as a function of the signals that are delivered by the actuating device 28.

Moreover, the operator can select a floating position at the selection instrument 26 for the hydraulic cylinder 28 by operating the control “floating position”, so that the electronic control unit 22 automatically transmits a corresponding control signal that switches the control valve 20 into the fourth position.

The difference between the controlled floating position with “zero pressure” and the adjustable, unregulated or zero pressure floating position (fourth switch position of the switch valve) consists of the fact that in the controlled floating position with “zero pressure” a stopping of the lifting linkage 30 by the build-up of a pressure in the rod side chamber 34 of the hydraulic cylinder is possible. In the uncontrolled floating position both chambers 32, 34 are at zero pressure.

In the course of the process shown in FIG. 7, the selection instrument 26 is initially activated by means of an activation switch (100). The operator can provide an input if a floating position (fourth switch position of the switch valve 20) is to be switched (102). Subsequently the operator selects the pressure control program (104). Corresponding to the selection of the pressure control program (106, 108, 110) the control program is initiated (114, 116, 118), where if necessary, a question of the pressure target value (112) is posed to the operator. Control signals 126 are generated corresponding to the operator's input of adjusting signals (124), except depending on the adjusting signals, corresponding to the selection of the pressure control program, also as a function of the prior input of the pressure target value (pressure target value input of 0 bar for “zero pressure” and pressure target value previously provided as input for “pressure input”) and the pressure values measured at the hydraulic cylinder (18) (126). The hydraulic cylinder is actuated as a function of the control signal (128). As a function of the pressure control program new pressure values are recalled from memory (122, 120) and are considered in the generation of the new control signal (126). The third pressure control program (manual) can be configured in such a way (for example, by a preceding input of an activating signal for this procedure) that if the electronic control unit 22 operates according to a different selected pressure control program or generated its control signal, then an automatic switching into the third pressure control program “manual” is performed, as soon as the actuating device 28 is actuated by the operator, that is, as soon as an adjusting signal is provided and is desired as input by the operator. The same can occur in case that the floating position had been selected previously. This has the advantage that the operator does not have to start the manual third pressure control program by means of the selection instrument 26, but by simply actuating the actuating device 28 and is switched into “manual” control. This however would also require that within the first and the second pressure control program in every correction of the hydraulic cylinder 18, in each time, it would be switched into the third pressure control program.

Therefore, provision can be made (for example, by prior input of an activation signal for this measure) that a monitoring or a combination of the pressure control “manual” with the pressure control (zero pressure) or (a pressure input) can be performed, so that, for example, a readjustment of the hydraulic cylinder by the operator can be performed without eliminating the pressure control. In that way, for example, in the pressure control program “zero pressure” the lifting linkage 30 can be raised, while the pressure in piston side chamber 32 is controlled to 0 bar. In the same manner, in the pressure control program “pressure input” the hydraulic cylinder 18 can be raised and lowered by adjusting signals from the operator, while the pressure in the piston side chamber 32 is controlled, where in this case a lowering can only occur within the parameter of the pressure target value previously provided as input, since the control limits the pressure to the pressure target value.

Moreover, it is also conceivable (for example, by an earlier input of an activation signal for this procedure) provision can be made upon actuation of the “manual” pressure control program on the basis of the actuation of the actuation device 28, for a return switch to the previously selected pressure control program, as long as an actuation of the actuation device 28 is again omitted. This has the advantage that corrections to the hydraulic cylinder 18 can be performed without a parallel pressure control and the pressure control program itself that was previously selected by the operator would be retained after the correction.

As described above, various pressure control programs can be activated or selected that permit the operation of the lifting arrangement 10 in various ways, or to make the pressure control conform to various applications for the hydraulic cylinder 18 connected to the lifting arrangement 30. Beyond that, various combinations or measures can be provided as input for the pressure control programs that can be selected or can be selected by means of the selection instrument.

In the following several applications or embodiments are described on the basis of the FIGS. 3 through 6, for the hydraulic lifting arrangement according to the invention described above in greater detail.

FIG. 3 shows a tractor 44 with a lifting arrangement 10, according to the invention, where the hydraulic cylinder 18 is applied for the lifting and lowering of a lifting linkage 30 configured as a front loader 42. The front loader 42 is equipped with an operating implement or an operating tool 70 in the form of a loader shovel 72, where other operating tools 70 can also be coupled to the front loader 42. The electronic control unit 22 as well as the selection instrument 26 and the actuating device 28 are arranged in the area of the cab 60. All further components are not shown here in the drawing. A lifting arrangement 10, according to the invention, is here appropriate particularly for loader operations, that, for example, perform a leveling of the ground, where a predetermined contact pressure can be adjusted for the loader shovel 72 by adjusting the pressure control program “pressure input” or for example, by selection of the pressure control program “zero pressure” in a “zero pressure” controlled floating position or by adjusting to the uncontrolled floating position or the operation can be performed in a zero pressure floating position.

FIG. 4 shows a tractor 44 with a lifting arrangement 10, according to the invention, where the hydraulic cylinder 18 is applied for the lifting and lowering of a lifting linkage 30 configured as a coupled attachment arrangement 46. The coupled attachment arrangement 46 is equipped with an operating implement or an operating tool 70 in the form of a packer roller 76, where other operating tools 70 can also be coupled to the coupling arrangement 46. The coupling arrangement 46 is preferably configured as a three point implement hitch or a three point hydraulic coupling, where a coupling is possible to the vehicle 40 or to the tractor 44 at its front side or at its rear side, as shown. The electronic control unit 22 as well as the selection instrument 26 and the actuating device 28 are arranged in the cab 60. Any further components are not shown in the drawing. A lifting arrangement 10, according to the invention, is appropriate in particular to perform ground breaking operations, for example, the rolling of a field, where a predetermined contact pressure can be provided by adjusting the pressure control program “pressure input” for the operating implement 70 (packer roller).

FIG. 5 shows a wheel loader 50 with a lifting arrangement 10 according to the invention, where the hydraulic cylinder 18 is applied for the lifting and lowering of the lifting linkage 30 configured as an oscillating crank 48. The wheel loader 50 is equipped with an operating implement or operating tool 70 in the form of an earth shovel 78, where other operating tools 70 could also be coupled to the wheel loader 50. The electronic control unit 22 as well as the selection instrument 26 and the actuating device 28 are arranged in the operator's cab 60. All other components are not shown here in the drawing. A lifting arrangement 10, according to the invention, is here particularly appropriate for the performance of ground breaking operations, such as, for example, the planing of the ground, where a predetermined contact pressure can be provided by the pressure control program “pressure input” for the earth shovel 78 or for example, by the selection of the pressure control program “zero pressure” in a “zero pressure” controlled floating position or the operation can be performed by adjusting the uncontrolled floating position or in a zero pressure floating position.

FIG. 6 shows a harvesting machine 56 in the form of a combine with a lifting arrangement 10 according to the invention, where the hydraulic cylinder 18 is applied for the raising and lowering of a lifting linkage 30 configured as an attached implement 52. The harvesting machine 56 is equipped with an operating implement or operating tool 70 in the form of a front harvesting attachment, where other operating tools 70 can also be coupled to the harvesting machine 56. The electronic control unit 22 as well as the selection instrument 26 and the actuating device 28 are arranged in the operator's cab 60. All further components are not shown here in the drawing. The harvesting machine 56 is configured, as an example, as a combine 80 with a cutter head 82. However, other types of harvesting machines 56 can also be provided with a lifting arrangement 10 according to the invention, for example, a forage harvester equipped with a corn cutter head.

Although the invention has been described in terms of a few embodiments, anyone skilled in the art will discern many varied alternatives, modifications, and variations in the light of the above description and the drawings, all of which are covered by the present invention.

1. Hydraulic lifting arrangement (10) for an industrial utility vehicle (40), particularly a construction machine or an agricultural vehicle, with a source (12) of hydraulic pressure, a hydraulic reservoir (14), at least one hydraulic cylinder (18), an actuation device (28) for the input of a positioning signal by an operator, an electronic control unit (22) and a hydraulic control valve (20) for the control of the hydraulic cylinder (18), where the control valve (20) can be controlled by the electronic control unit (22), characterized by a pressure sensor (24) connected to the hydraulic cylinder (18) and a selection instrument (26) that is provided for the selection of at least one pressure control program for the hydraulic cylinder (18), where the control valve (20) can be controlled by a control signal generated by the electronic control unit (22), which can be generated as a function as a selection of the pressure control program and/or by a pressure signal delivered by a pressure sensor (24) and/or by the adjusting signal from the operator.

2. Hydraulic lifting arrangement (10) according to claim 1, characterized by a lifting linkage (30) that is provided for the lifting and lowering of an operating implement 70 and the hydraulic cylinder (18) is connected to the lifting linkage (30) that was provided, and is connected to a chamber (32, 34) that can be supplied with pressure for the retraction and extension of the hydraulic cylinder (18), where the retraction and extension of the hydraulic cylinder (18) is associated with the lifting and a lowering of the lifting linkage (30).

3. Hydraulic lifting arrangement (10) according to claim 1 or 2, characterized by the pressure sensor (24) that is connected hydraulically with the chamber (32) that can be supplied with pressure for the lowering of the lifting linkage (30).

4. Hydraulic lifting arrangement (10) according to one of the preceding claims; characterized by the control valve (20) that is configured as a proportional valve in the form of a 4/4 way or 4/3 way valve.

5. Hydraulic lifting arrangement (10) according to one of the claims 2 through 4, characterized by the control unit (22) that is configured in such a way that a control signal can be generated with a first pressure control program with which the chamber (32) used for the lowering of the lifting linkage (30) is held at zero pressure.

6. Hydraulic lifting arrangement (10) according to one of the claims 2 through 5, characterized by the control unit (22) that is configured, in such a way that a control signal can be generated with the second pressure control program, with which the pressure in the chamber (32) for the lowering of the lifting linkage (30) is held to a pressure that can be provided as input by the selection instrument (26).

7. Hydraulic lifting arrangement (10) according to one of the claims 2 through 6, characterized by the control unit (22) that is configured in such a way that a control signal can be generated with a third pressure control program with which the pressure in the chamber (32) supplied for the lowering of the lifting linkage (30) and in the chamber (34) that can be supplied with pressure for the raising of the lifting linkage (30) can be varied.

8. Hydraulic lifting arrangement (10) according to one of the preceding claims, characterized by the control valve (20) that can be actuated electro-magnetically by means of electro-magnetic coils (62).

9. Hydraulic lifting arrangement (10) according to one of the preceding claims, characterized by the control valve (20) that can be actuated electro-mechanically by means of a stepper motor (66).

10. Hydraulic lifting arrangement (10) according to one of the claims 2 through 9, characterized by the lifting linkage (30) that is configured as a coupling arrangement (46), particularly a three point hydraulic coupling arrangement for a front- or a rear operating implement.

11. Hydraulic lifting arrangement (10) according to one of the claims 2 through 9, characterized by the lifting linkage (30) that is configured as a front loader (42) for an agricultural vehicle, particularly for a tractor (44).

12. Hydraulic lifting arrangement (10) according to one of the claims 2 through 9, characterized by the lifting linkage (30) that is configured as an attaching linkage (52) for a front harvesting attachment (54) for an agricultural vehicle, particularly a harvesting machine (56).

13. Hydraulic lifting arrangement (10) according to one of the claims 2 through 9, characterized by the lifting linkage (30) that is configured as an oscillating crank (48) for a construction machine, particularly for a wheel loader (50), or a planing roller.

14. Process for the control for a hydraulic lifting arrangement (10) for an industrial utility vehicle (40), particularly a construction machine or an agricultural vehicle, with a source (12) of hydraulic pressure, a hydraulic reservoir (14), a double-acting hydraulic cylinder (18), an actuating device (28) for the input of a positioning signal by an operator, an electronic control unit (22), and a hydraulic control valve (20) for the control of the hydraulic cylinder (18), where the control valve (20) can be controlled by the electronic control unit (22), characterized by a pressure sensor (24) and a selection instrument (26) that are provided for the selection of at least one pressure control program for the hydraulic cylinder (18), where the control valve (20) is controlled by a control signal generated by the control unit (22), that is generated as a function of the selection of the pressure control program and/or by a pressure signal delivered by the pressure sensor (24) and/or by the adjusting signal from the operator.

15. Process according to claim 14), characterized by the hydraulic cylinder (18) that is connected with a lifting linkage (30) provided for the raising and lowering of an operating implement (70) and is provided with a chamber (32, 34) that can be supplied with pressure for the retraction and extension of the hydraulic cylinder (18), where a retraction or extension of the hydraulic cylinder (18) is associated with a raising or lowering of the lifting linkage (30).

16. Process according to one of the claim 14 or 15 characterized by a control signal that is generated by the control unit (22) with a first pressure control program, with which the pressure in the chamber (32) that can be supplied with pressure for the lowering of the lifting linkage (30) is held to zero bar.

17. Process according to one of the claims 14 through 16, characterized by the control unit (22) that generates a signal with second pressure control program, with which the pressure in the chamber (32), that can be supplied with pressure for the lowering of the lifting linkage (30), is held to a constant pressure that can be provided as input by the selection instrument (26).

18. Process according to one of the claims 14 through 17, characterized by the control unit (22) that generates a control signal with a third pressure control program, with which the pressure in the chamber (32) that can be supplied with pressure for the lowering of the lifting linkage (30) and the pressure supplied to the chamber (34) for the raising of the lifting linkage (30) can be varied.

19. Industrial utility vehicle (40), particularly a construction machine or an agricultural vehicle, characterized by the utility vehicle (40) that is provided with a lifting arrangement (10) according to one of the claims 1 through 13.

20. Construction machine, particularly a wheel loader (50) or earthmover characterized by the construction machine that is provided with a hydraulic lifting arrangement (10) according to one of the claims 1 through 9 or 13.

21. Agricultural vehicle, particularly a tractor (44) or a harvesting machine (56) characterized by the agricultural vehicle that is provided with a hydraulic lifting arrangement (10) according to one of the claims 1 through 12.
